(19) United States
(12) Patent Application Publication
(10) Pub. No.: US 2006/0065492 A1
(43) Pub. Date: Mar. 30, 2006

(54) Display systems and methods having individually addressable monitor units

(76) Inventor: Victor Trifu, Cropseyville, NY (US)

Correspondence Address: DINSMORE & SHOHL, LLP, 1900 CHEMED CENTER, 255 EAST FIFTH STREET, CINCINNATI, OH, 45202, US

(21) Appl. No.: 11/235,883

(22) Filed: Sep. 27, 2005

Related U.S. Application Data
(60) Provisional application No. 60/613,534, filed on Sep. 27, 2004.

(51) Int. Cl. B66B 1/34

(52) U.S. Cl. 187/396; 187/393

(57) ABSTRACT

A display system includes multiple monitor units which each include an enclosure, a display screen, a communication port, a storage device, and a control circuit. A communications conduit sequentially connects the monitor units and is selectively connectable with a general purpose computer. Each monitor unit is individually addressable over the communications conduit by a general purpose computer for receiving individualized control information and image information therefrom. The control circuit of each of the monitor units is configured to store the control information and the image information within the storage device, and is further configured to act in accordance with the stored control information to selectively provide at least some of the stored image information to the display screen. The control circuit does not include a general purpose computer and is unable to operate an off-the-shelf operating system. An elevator system is also provided, as are methods of displaying information.

### RELATED APPLICATION

The present application claims priority of U.S. Provisional Application Ser. No. 60/613,534 filed Sep. 27, 2004, and hereby incorporates herein by reference the same Provisional Application (including, but not limited to, “Appendix A” entitled “Lobby Intercom Display, Version 3”).

### TECHNICAL FIELD

The present invention relates to display systems and methods having individually addressable monitor units. By way of example, these display systems and methods can be used to display advertisements and the like, and can include monitor units that are located, for example, within elevator cabs and/or within elevator lobbies.

### BACKGROUND OF THE INVENTION

Time spent by elevator passengers riding in an elevator cab and/or waiting within an elevator lobby for an elevator cab to arrive is typically wasted. During such circumstances, it is typical for such persons to feel awkward, and they accordingly may strive to avoid making eye contact with other passengers. Accordingly, there is a need for an improvement in elevator cabs and elevator lobbies that facilitates effective time usage by those persons riding in an elevator cab or waiting within an elevator lobby.

### SUMMARY OF THE INVENTION

Accordingly, it is one aspect of the present invention to provide an improvement in elevator cabs and elevator lobbies that facilitates effective time usage by those persons riding in an elevator cab or waiting within an elevator lobby. To achieve the foregoing and other aspects, and in accordance with the purposes of the present invention defined herein, display systems and methods having individually addressable monitor units are disclosed.

In one embodiment of the present invention, a display system is provided that includes a plurality of monitor units. Each monitor unit comprises an enclosure, a display screen, a communication port, a power port, a storage device, and a control circuit. The control circuit is electrically connected with each of the display screen, the communication port, the power port, and the storage device. The enclosure supports each of the display screen, the communication port, the power port, the storage device, and the control circuit. The control circuit does not comprise a general purpose computer and is unable to operate an off-the-shelf operating system. A communications conduit is sequentially connected to the communication port of each of the monitor units. The communications conduit is configured to be selectively connected with a general purpose computer, wherein each of the monitor units is individually addressable over the communications conduit by a general purpose computer for receiving individualized control information and image information from a general purpose computer. The control circuit of each of the monitor units is configured to store the control information and the image information within the storage device, and is further configured to act in accordance with the stored control information to selectively provide at least some of the stored image information to the display screen.

In another embodiment of the present invention, an elevator system is provided for movement of passengers among respective floors of a building. The elevator system comprises at least one elevator cab that is moveably supported within an elongated vertical passageway. The passageway extends adjacent to a plurality of lobbies. Each lobby is located upon a distinct floor of a building. The elevator cab is configured to receive passengers from at least some of the plurality of lobbies. A control system is connected with the elevator cab and is configured to selectively move the elevator cab through the passageway. A display system comprises a plurality of monitor units that are disposed in locations visible to elevator passengers. Each monitor unit comprises an enclosure, a display screen, a communication port, a power port, a storage device, and a control circuit. The control circuit is electrically connected with each of the display screen, the communication port, the power port, and the storage device. The enclosure supports each of the display screen, the communication port, the power port, the storage device, and the control circuit. The control circuit does not comprise a general purpose computer and is unable to operate an off-the-shelf operating system. A communications conduit is sequentially connected to the communication port of each of the monitor units. The communications conduit is configured to be selectively connected with a general purpose computer, wherein each of the monitor units is individually addressable over the communications conduit by a general purpose computer for receiving individualized control information and image information from a general purpose computer. The control circuit of each of the monitor units is configured to store the control information and the image information within the storage device. The control circuit is further configured to act in accordance with the stored control information to selectively provide at least some of the stored image information to the display screen.

In yet another embodiment of the present invention, a method of displaying image information on a plurality of monitor units is provided. The method comprises providing a first monitor unit, a second monitor unit, a communications conduit, and a general purpose computer. The first monitor unit is mounted in a first location. The first monitor unit comprises a first enclosure, a first display screen, a first communication port, a first power port, a first storage device, and a first control circuit. The first control circuit is electrically connected with each of the first display screen, the first communication port, the first power port, and the first storage device. The first enclosure supports each of the first display screen, the first communication port, the first power port, the first storage device, and the first control circuit. The first control circuit does not comprise a general purpose computer and is unable to operate an off-the-shelf operating system. The second monitor unit is mounted in a second location. The second monitor unit comprises a second enclosure, a second display screen, a second communication port, a second power port, a second storage device, and a second control circuit. The second control circuit is electrically connected with each of the second display screen, the second communication port, the second power port, and the second storage device. The second enclosure supports each of the second display screen, the second communication port, the second power port, the second storage device, and the second control circuit. The second control circuit does not comprise a general purpose computer and is unable to operate an off-the-shelf operating system. The communications conduit is connected to the first communication port and to the second communication port in a sequential arrangement. The general purpose computer is connected to the communications conduit. Control information and image information are transferred from the general purpose computer to the first monitor unit over the communications conduit. The control information and the image information received by the first monitor unit are stored within the first storage device. Control information and image information are transferred from the general purpose computer to the second monitor unit over the communications conduit. The control information and the image information received by the second monitor unit are stored within the second storage device. At least some of the stored image information in the first storage device is provided to the first display screen in accordance with the stored control information in the first storage device. At least some of the stored image information in the second storage device is provided to the second display screen in accordance with the stored control information in the second storage device.

In still another embodiment of the present invention, a method of displaying advertisements on a monitor unit is provided. The monitor unit is connected sequentially along a communications conduit with other monitor units and is individually and selectively addressable by a general purpose computer over the communications conduit. The method comprises providing a monitor unit having a storage device, a control circuit, and a display. The control circuit is connected with a communications conduit. The control circuit does not comprise a general purpose computer and is unable to operate an off-the-shelf operating system. Control information and image information are received by the monitor unit from a general purpose computer over the communications conduit. The image information comprises a plurality of advertisement images. The control information and the image information are stored within the storage device. The control information and the image information are processed with the control circuit. At least some of the image information is displayed upon the display as directed by the control information.

Accordingly, the present invention is advantageous for providing an improvement in elevator cabs and elevator lobbies that facilitates effective time usage by those persons riding in an elevator cab or waiting within an elevator lobby. Additional aspects, advantages, and novel features of the invention will be set forth in part in the description that follows, and in part will become apparent to those skilled in the art upon examination of the following, or may be learned with the practice of the invention. The aspects and advantages of the invention may be realized or attained by means of the instrumentalities and combinations as set forth herein and as will be apparent to those of ordinary skill in the art.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a schematic view depicting a building having an elevator system having a display system in accordance with one embodiment of the present invention;

FIG. 2 is a schematic view depicting the display system of FIG. 1, including aspects not shown in FIG. 1 such as a communication conduit and a general purpose computer;

FIG. 3 is a perspective view depicting the external frontal appearance of the monitor units of FIGS. 1-2; and

FIG. 4 is a structural block diagram generally depicting the electronic configuration of the monitor units of FIGS. 1-3.

### DETAILED DESCRIPTION OF EMBODIMENTS

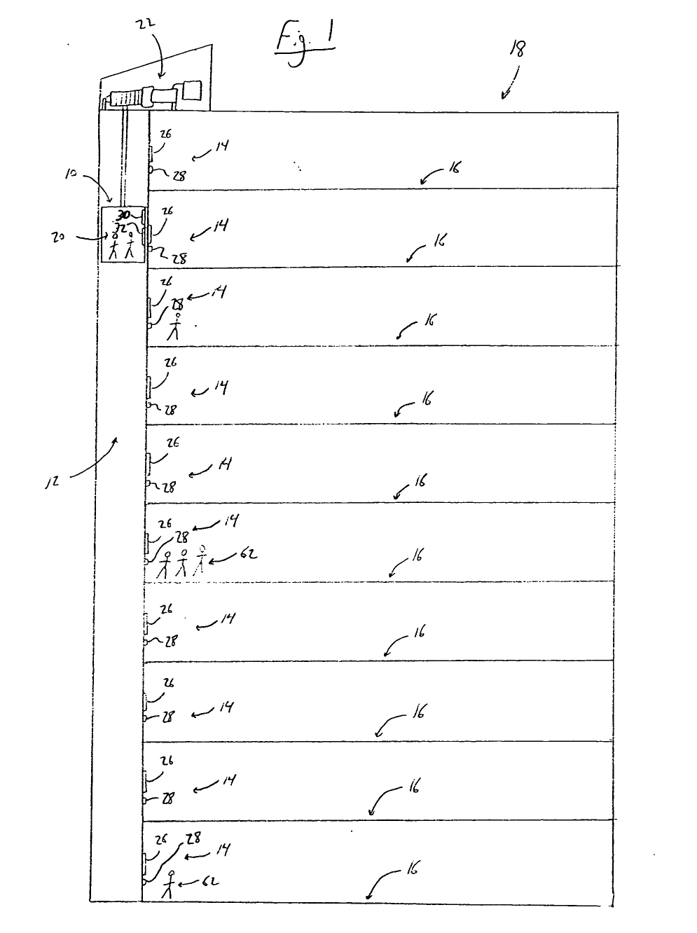

The present invention and its operation is hereinafter described in detail in connection with the views and examples of FIGS. 1-4 wherein like numbers indicate the same or corresponding elements throughout the views. FIG. 1 depicts a building 18 having a vertical passageway 12 and an elevator system 11. The elevator system 11 is shown to include one elevator cab 10, although it will be understood that an elevator system in accordance with the teachings of the present invention may include any number of elevator cabs.

In the embodiment of FIG. 1, elevator cab 10 is supported by cables from an overhead control system 22. The control system 22 can include any and all components that are required and/or used to facilitate controlled vertical movement of the elevator cab 10 within the vertical passageway 12. The elevator cab 10 can accordingly be moved by the control system 22 between any of a variety of floors 16 of the building 18. An elevator lobby 14 can be provided on each floor 16 near the location at which the elevator cab 10 can be accessed for ingress or egress by passengers (e.g., 20). As used herein, the term “elevator lobby” merely refers to the area adjacent the elevator doors on each floor (i.e., the area where prospective elevator passengers wait for an elevator). The elevator lobby need not be physically separate or isolated from other parts of the building.

Elevator cab 10 is shown to have a pushbutton panel 32 that is configured to receive floor selections and other input from passengers 20. Likewise, pushbutton panels 28 can be provided within each elevator lobby 14 and can be configured to enable prospective elevator passengers (e.g., 62) to call the elevator cab 10 to their floor location.

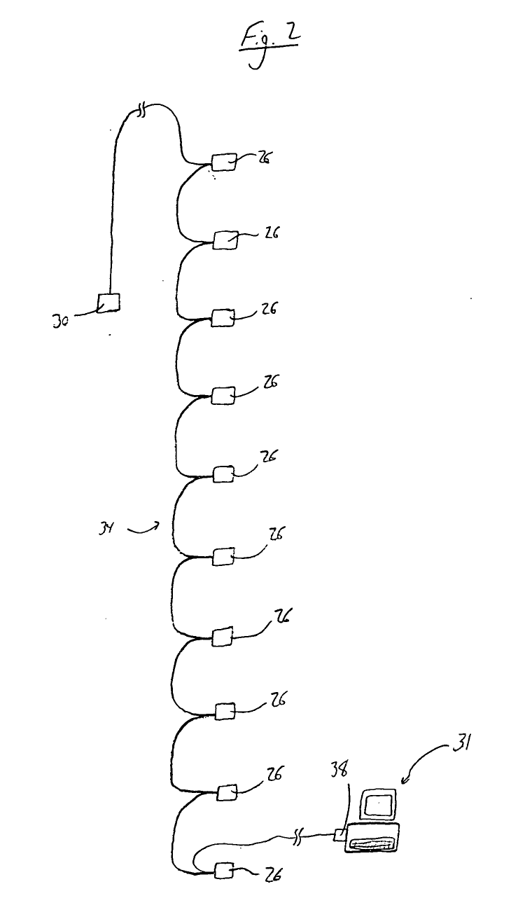

Referring now to FIGS. 1 and 2, elevator system 11 includes a display system comprising one or more individual monitor units 26 located in one or more of the elevator lobbies 14, and/or one or more individual monitor units 30 located in one or more of the elevator cabs 10. For example, one display system includes monitor units within multiple elevator lobbies associated with one or more elevator cabs, but does not include any monitor units within the elevator cabs. Alternatively, a display system can include monitor units within multiple elevator cabs, but might not include any monitor units within elevator lobbies. As still another example, as shown for example in FIG. 1, a display system includes monitor units within one or more elevator cabs 10 and within one or more elevator lobbies 14. A display system in accordance with the present invention can include as few as two monitor units, and can include as many monitor units as are desired.

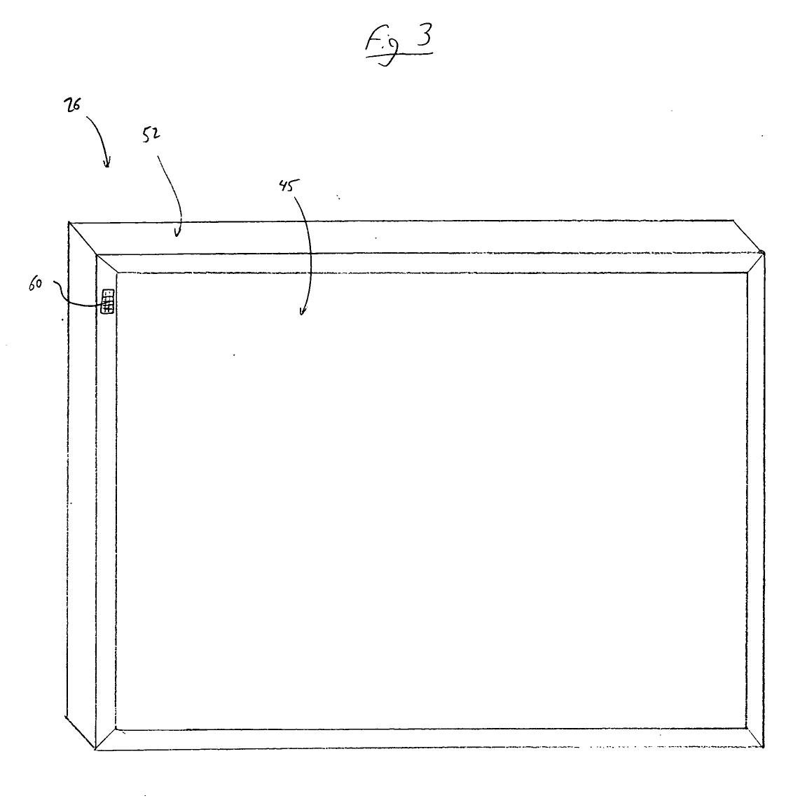

The external configuration of the monitor unit 26 is depicted in FIG. 3. The monitor unit 26 is shown to include an enclosure 52 that partially surrounds and protects the edges of a display screen 45. The display screen 45 can be of any of a variety of display types, particularly a flat panel display device (e.g., LCD, TFT). The enclosure 52 is also shown to include an optional motion sensor 60, to be discussed hereinafter in further detail. It will be appreciated that the external configuration of the monitor unit 26 (e.g., enclosure 52) can assume any of a variety of specific shapes and orientations. However, in one embodiment of the present invention, the enclosure 52 is configured such that it can be mounted directly upon a wall (e.g., the wall of an elevator cab or elevator lobby) without recessing into the wall, and protruding from the wall by less than about 1.0 inch (2.5 cm), or even about 0.5 inch (1.3 cm). By not requiring any recess into the wall, installation time for the monitor unit 26 can be greatly reduced. Also, by having a thin profile from the wall, the monitor unit 26 (e.g., enclosure 52) is less likely to sustain damage from passengers (e.g., 20), and passengers are less likely to be injured through inadvertent contact with the monitor unit 26. For these reasons, the thinnest possible profile is desired.

In order to achieve the thinnest possible profile and overall smallest possible enclosure size, it will be appreciated that the components of the monitor unit are carefully selected to balance flexibility and functionality with size reduction. To achieve this result, the monitor unit 26 does not include a general purpose computer. A general purpose computer (e.g., a DOS- or Windows-based personal computer) is not desirable for implementation as a monitor unit in the present invention due to its relatively large physical size and its complexity as compared to that required of the monitor units described herein. Also, a general purpose computer, due to its complicated software and hardware architecture, can be considerably less reliable than a monitor unit described herein. Furthermore, because the monitor units described herein generally include less components than a general purpose computer, the price of a monitor unit can be significantly less than a general purpose computer. Also, because the monitor units involve fewer components than a general purpose computer, their power consumption is also generally lower. By not including a general purpose computer, a monitor unit in accordance with the teachings of the present invention might not be configured to interface with communications protocols which are typically native to general purpose computers such as, for example, Ethernet and TCP/IP.

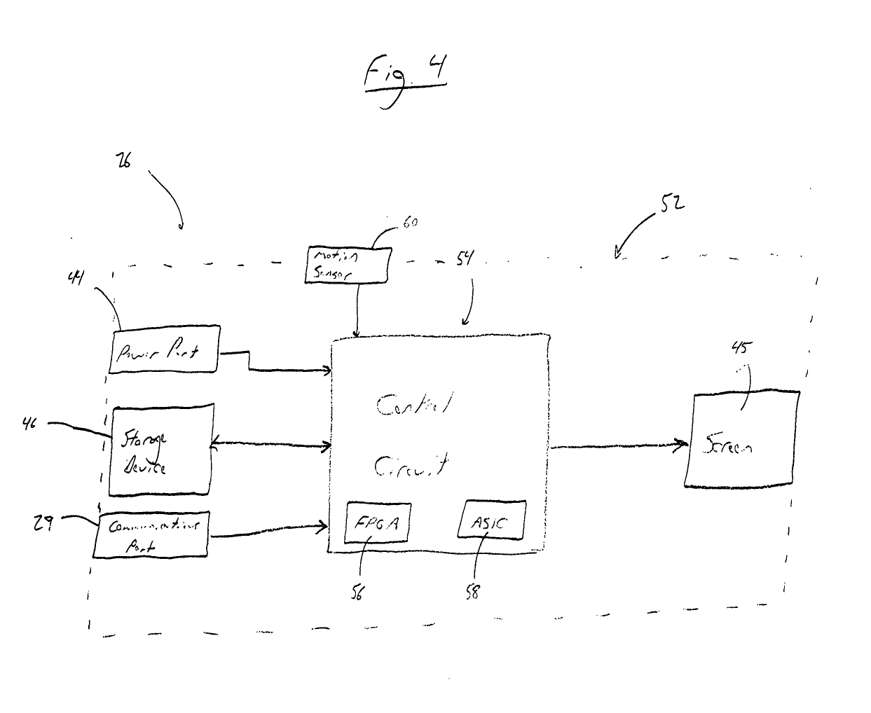

FIG. 4 depicts in block form one illustrative electronic configuration of a monitor unit 26. This same configuration may be used for a monitor unit 30 within a cab 10. The screen 45 receives signals from a control circuit 54. The control circuit 54 can include any of a variety of components, including, for example, a field programmable gate array (FPGA) 56, an application specific integrated circuit (ASIC) 58, a processor, and/or any of a variety of other components. Control circuit 54 receives power from a power input port 44. It should be appreciated that a power conditioning circuit might also be provided as part of power port 44, control circuit 54, and/or between power port 44 and control circuit 54. Such a power conditioning circuit can ensure that an appropriate power signal is transmitted to the control circuit 54.

Control circuit 54 is also connected with a storage device 46. The storage device 46 can be configured to store image information (e.g., containing images for display upon the display screen 45). The storage device 46 might also be configured to store control information (e.g., for instructing the control circuit 54 as to which of the stored data images to display on the display screen 45 at any particular time). In one embodiment, the storage device 46 may comprise a receptacle along with a removable memory card. It will be appreciated that this removable memory card can assume any of a variety of formats, such as, for example, Smart Media, Memory Stick, Multimedia Card, Secure Digital, Compact Flash, and/or many others. Advantages of removable memory cards include ease of memory enhancement, ease of replacement of faulty memory, ease of data content replacement, and many others. Although both the image information and the control information may be stored on a removable memory card, in some embodiments, only the image information is stored on the removable memory card while the control information is stored in a separate (and possibly non-removable) storage device (e.g., BIOS memory) that is associated with the control circuit. Image information can be formatted and/or stored upon a removable memory card in a manner different than that which is familiar to a digital camera (i.e., so that a monitor unit could not extract image information from a memory card taken directly from a digital camera).

In other embodiments, no portion of the storage device 46 is removable (e.g., the entire storage device might be soldered in place). Advantages of non-removable memory include reduced cost, increased speed, increased reliability, and others. Although volatile memory may be employed, it will be appreciated that non-volatile memory will desirably be used in order that the image information is not lost if power to the power port 44 is interrupted.

A communications port 29 may also be provided, and may be connected with the control circuit 54. As will be described in further detail below, communications port 29 can be adapted to receive image information and/or control information from a remote source such as a general purpose computer. Any of a variety of data formats might be employed, as discussed in further detail below.

As shown in FIGS. 3-4, the enclosure 52 can directly or indirectly support (e.g., by connecting with or otherwise surrounding or housing) each of the display screen 45, the communication port 29, the power port 44, the storage device 46, and the motion sensor 60. Although not particularly depicted in FIGS. 1-4, it should be appreciated that the power port 44 and the communications port 29 can be disposed upon a location of the enclosure 52 that is suitable to interface with connecting wires (e.g., from behind the enclosure 52, or through conduit attaching to one of the edges of the enclosure 52).

It will be appreciated that a display system in accordance with the teachings of the present invention can include monitor units that are connected sequentially by a communications conduit 34, as shown for example in FIG. 2. This communications conduit 34 can include any of a variety of specific wire conductor combinations and/or arrangements, and/or can communicate using any of a variety of available communications protocols. In certain embodiments of the present invention, a communications conduit might employ a serial communications protocol which cannot, without provision of additional interface hardware, interface with a general purpose computer. For example, the communication conduit might employ a protocol other than one selected from the group consisting of Ethernet and TCP/IP, such as, for example, any of an RS-485 protocol, an RS-422 protocol, an RS-232 protocol, a CANBUS protocol, a PROFIBUS protocol, an INTERBUS protocol, a FOUNDATION FIELDBUS protocol, and a DEVICENET protocol.

It will be appreciated that a sequential connection among individual monitor units (e.g., as shown in FIG. 2) avoids the need for individual wires leading from each of the monitor units to a central location (e.g., a hub). Hence, a single cable can provide a communications conduit to multiple monitor units in order to provide such a sequential connection. Again, the exact connection details will depend in large part upon the communications protocol that is selected, and are well known by those skilled in the art.

The monitor units of the present invention are configured to receive image information and control information over the communications conduit, and then to resultantly display the image information in accordance with instructions provided within the control information. The monitor units therefore are not configured to display image information in real time as the image information is received over the communications conduit (e.g., they are not configured like television sets receiving cable television signals). Furthermore, different image information and control information can be provided to respective monitor units within a display system in accordance with the teachings of the present invention. To provide such functionality, each monitor unit can be individually addressable upon the communications conduit. In one particular example, a two-wire RS-485 connection can be provided to connect multiple monitor units within a display system (e.g., as in FIG. 2).

A connector 38 might also be provided at some point along the communications conduit 34. The connector 38 can be configured to selectively interface a general purpose computer 31, as shown for example in FIG. 2. This general purpose computer 31 can be used to download new image information and/or control information to any of the monitor units at any time (i.e., through individually addressing the new information to the particular monitor unit over the communications conduit). After suitable information has been downloaded to the monitor units, it should be appreciated that the general purpose computer 31 can be disconnected from the connector 38, can be taken from the premises, and/or can be powered down. After this information has been downloaded to the individual monitor units, it should therefore be appreciated that the general purpose computer 31 has no ongoing role in the operation of the monitor units. Rather, the general purpose computer 31 serves only as a download tool, not as a server.

One advantage of this system is that there is no need for a general purpose computer dedicated to the task of overseeing the monitor units. Rather, a laptop (a variety of general purpose computer) or other portable device may be connected to download new information to the monitor units only periodically (e.g., daily, weekly or monthly). As another advantage, because the information is not displayed on the monitor units in real time as it is transferred to the monitor unit, the data transfer speed need not be very high, and slower data transfer protocols (e.g., such as RS-485) can be effectively employed. These slower data transfer protocols are often simpler and less expensive to install and maintain than higher speed protocols that would be necessary to provide real time display of images as they are downloaded from a general purpose computer. Also, information need not ever be transmitted back from a monitor unit to the general purpose computer (although such reverse transmission may occur to enable the general purpose computer to verify that a monitor unit has received certain data).

To install a display system in accordance with the present invention, monitor units can be hung upon walls of elevator cabs and/or elevator lobbies of an elevator system. Power can be provided to each of the monitor units from any of a variety of power supplies that may be local to the individual monitor units. The communications conduit can be connected as discussed above. A general purpose computer may then be temporarily connected with the communications conduit. Through use of the general purpose computer, control information and image information can then be individually sent to each of the monitor units over the communications conduit. The image information can comprise images such as JPEG, TIFF, BMP, GIF, PNG or any of a variety of other data types. The control information can instruct the monitor units as to how to display the image information. For example, the control information can constitute a series of scripts, each of which can indicate an image to display and a length of time for display of that image. As the control circuit processes the control information, each of these scripts is acted upon in succession, thereby causing the desired sequence of images to be displayed on the display screen. The control information might also include additional information as well, such as specific aspects regarding the manner in which images shall be removed and/or placed upon the display (e.g., fade in/out).

In one specific example, a general purpose computer may be used to download image information to a monitor unit that includes eighty JPG images, as well as control information containing eighty script commands. Each image may be a separate advertisement, and the script commands may be written such that each image appears on the display screen for ten seconds, thereby enabling passengers sufficient time to view and absorb all of the information within each image. After all of the images have been displayed, the script commands repeat until new control information is downloaded from the general purpose computer. In an alternate example, the image information might include ninety images, but the scripts might cycle images fifteen times per second (or more frequently), thereby resulting in the appearance of a six second video on the display screen. It should be appreciated that virtually any combination of still images and video (i.e.: quickly sequenced still images) can be displayed upon a given monitor unit. A monitor unit might also be provided with a speaker in order that audio can be provided in connection with the images or in lieu of the images.

The progression of scripts may also be related to a motion sensor optionally provided within (or in close proximity to) a monitor unit. For example, if a motion sensor detects passengers, the script may be started such that images are displayed. In another embodiment, the motion sensor might merely control whether the backlight for the display screen is activated. Providing a motion sensor can thereby disable at least some components of a monitor unit when passengers are not present, thus conserving energy and extending the useful life of the monitor unit.

While images cannot be downloaded to and displayed by the monitor units in real time, control information (e.g., scripts) can be downloaded to a monitor unit in real time (i.e., nearly instantaneous, as compared to the time necessary for an elevator to move between floors). Control information, once received by a monitor unit, can cause an already stored image within the storage device of a monitor unit to be displayed in real time. Accordingly, the images presented on a monitor unit can be controlled in real time, provided that the images themselves had been previously stored in the local memory (e.g., the storage device) of the monitor unit. For example, if a building has ten floors (e.g., as in FIG. 1), ten images might be stored within the storage device of a monitor unit, wherein each of the ten images presents one of the numbers from one to ten. An elevator controller may then be coupled with the communications conduit that connects each of the monitor units, and can be configured to generate a new script indicative of floor location as an elevator cab moves among floors. A monitor unit can receive these scripts in real time and can resultantly call for the display of the appropriate floor location image for display upon the screen in real time when the elevator cab is approximately aligned with that floor. Other command information that may be passed to the monitor units might include building fire alarm status information, for example. Furthermore, it should be appreciated that a display screen of a monitor unit might display more than one image at any given time. For example, part of the display screen might be used to display an advertisement while another part of the display screen can be simultaneously used to display an image corresponding to building floor location.

Using the display systems and methods provided herein, it will be appreciated that passengers within an elevator cab and/or an elevator lobby can be presented with advertisements during their time waiting on or for an elevator cab. While the passengers may enjoy having these advertisements to occupy their waiting time, the building managers may profit by selling this advertising time to vendors. In the elevator system context, it should also be appreciated that the display system might be configured to display, either in addition to or in lieu of advertisements, information concerning weather, geographic aspects, elevator cab location information, product information, service information, and building occupant directory information, or any other information of interest to passengers.

The display systems and methods described herein may also be used in locations not involving elevator systems. For example, such a display system might be installed within a retail store, wherein individual monitor units are positioned at various locations around the store, such as near respective products being sold. Such monitor units could then provide dynamic information regarding those products. As another example, such a display system might be installed within a museum or other public exhibit, wherein individual monitor units can be placed near particular items or groupings of items within the exhibit. Information regarding those items or groupings can then be dynamically displayed upon the monitor units.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A display system comprising:
a plurality of monitor units each comprising an enclosure, a display screen, a communication port, a power port, a storage device, and a control circuit, the control circuit being electrically connected with each of the display screen, the communication port, the power port, and the storage device, the enclosure supporting each of the display screen, the communication port, the power port, the storage device, and the control circuit, wherein the control circuit does not comprise a general purpose computer and is unable to operate an off-the-shelf operating system;
a communications conduit being sequentially connected to the communication port of each of the monitor units, the communications conduit being configured to be selectively connected with a general purpose computer, wherein each of the monitor units is individually addressable over the communications conduit by a general purpose computer for receiving individualized control information and image information from a general purpose computer;
wherein the control circuit of each of the monitor units is configured to store the control information and the image information within the storage device, and is further configured to act in accordance with the stored control information to selectively provide at least some of the stored image information to the display screen.

2. The display system of claim 1 wherein the communication conduit does not employ a protocol selected from the group consisting of Ethernet and TCP/IP.

3. The display system of claim 1 wherein the enclosure is configured to be wall-mounted such that no portion of the monitor unit recesses into a wall, and such that no portion of the monitor unit protrudes from a wall by more than about 0.5 inches (1.3 centimeters).

4. The display system of claim 1 wherein the enclosure is configured to be wall-mounted such that no portion of the monitor unit recesses into a wall, and such that no portion of the monitor unit protrudes from a wall by more than about 1.0 inches (2.5 centimeters).

5. The display system of claim 1 wherein said monitor units do not comprise any viewer accessible controls.

6. The display system of claim 1 further comprising a motion sensor being electrically connected with the control circuit of at least one of the monitor units, the motion sensor being supported by the enclosure of the at least one of the monitor units and being configured to generate activation signals, the control circuit being operative to selectively display the image information on the display screen at least partially in response to the activation signals.

7. The display system of claim 1 wherein the storage device comprises non-volatile memory.

8. The display system of claim 1 being configured to display information selected from the group consisting of advertisements, weather information, geographic information, elevator cab location information, product information, and service information.

9. The display system of claim 1 wherein the control circuit consists essentially of at least one of a field programmable gate array and an application specific integrated circuit.

10. The display system of claim 1 wherein a general purpose computer need not be continually connected with the communications conduit during operation of the monitors.

11. The display system of claim 1 wherein said control circuit is not configured to display the image information on the display screen in real time as the image information is received from a general purpose computer via the communications conduit.

12. The display system of claim 1 wherein the control circuit of each of said monitor units is configured to receive image information representing time of day from the communications conduit, and to effectuate display of time of day on the display screen.

13. The display system of claim 12 wherein the control circuit of each of said monitor units is configured to receive image information in real time representing time of day from the communications conduit, and to effectuate display of time of day on the display screen.

14. The display system of claim 12 wherein the control circuit of each of said monitor units comprises an internal clock and the control circuit is configured to effectuate display of time of day on the display screen in response to data from the internal clock, wherein the internal clock is configured for periodic calibration by the control circuit in response to image information representing time of day which is periodically transmitted over the communications conduit to each of the monitor units.

15. The display system of claim 12 wherein the image information representing time of day is generated by a global positioning system receiver external to the monitor units.

16. An elevator system for movement of passengers among respective floors of a building, the elevator system comprising:
at least one elevator cab being moveably supported within an elongated vertical passageway, the passageway extending adjacent to a plurality of lobbies, each lobby being located upon a distinct floor of a building, the elevator cab being configured to receive passengers from at least some of the plurality of lobbies;
a control system being connected with said elevator cab and being configured to selectively move said elevator cab through said passageway;
a display system comprising a plurality of monitor units being disposed in locations visible to elevator passengers, each monitor unit comprising an enclosure, a display screen, a communication port, a power port, a storage device, and a control circuit, the control circuit being electrically connected with each of the display screen, the communication port, the power port, and the storage device, the enclosure supporting each of the display screen, the communication port, the power port, the storage device, and the control circuit, wherein the control circuit does not comprise a general purpose computer and is unable to operate an off-the-shelf operating system;
a communications conduit being sequentially connected to the communication port of each of the monitor units, the communications conduit being configured to be selectively connected with a general purpose computer, wherein each of the monitor units is individually addressable over the communications conduit by a general purpose computer for receiving individualized control information and image information from a general purpose computer;
wherein the control circuit of each of the monitor units is configured to store the control information and the image information within the storage device, and is further configured to act in accordance with the stored control information to selectively provide at least some of the stored image information to the display screen.

17. The elevator system of claim 16 wherein at least some of the locations are within elevator lobbies.

18. The elevator system of claim 16 wherein at least some of the locations are within elevator cabs.

19. The elevator system of claim 16 wherein at least some of the locations are within elevator lobbies and wherein at least some of the locations are within elevator cabs.

20. The elevator system of claim 16 wherein the communication conduit does not employ a protocol selected from the group consisting of Ethernet and TCP/IP.

21. The elevator system of claim 16 wherein said enclosure is configured to be wall-mounted such that no portion of said monitor unit recesses into a wall, and such that no portion of said monitor unit protrudes from a wall by more than about 1.0 inches (2.5 centimeters).

22. The elevator system of claim 16 wherein said monitor units do not comprise a passenger-accessible control.

23. The elevator system of claim 16 further comprising a motion sensor being electrically connected with the control circuit of at least one of the monitor units, the motion sensor being supported by the enclosure of the at least one of the monitor units and being configured to generate activation signals, the control circuit being operative to selectively display the image information on the display screen at least partially in response to the activation signals.

24. The elevator system of claim 16 wherein the storage device comprises non-volatile memory.

25. The elevator system of claim 16 wherein the monitor units are configured to display advertisements.

26. The elevator system of claim 16 wherein the monitor units are configured to display information selected from the group consisting of weather information, geographic information, elevator cab location information, product information, and service information.

27. The elevator system of claim 16 wherein the control circuit consists essentially of at least one of a field programmable gate array and an application specific integrated circuit.

28. The elevator system of claim 16 wherein a general purpose computer need not be continually connected with the communications conduit during operation of the monitors.

29. The elevator system of claim 16 wherein said control circuit is not configured to display the image information on the display screen in real time as the image information is received from a general purpose computer via the communications conduit.

30. The elevator system of claim 16 wherein the control circuit of each of said monitor units is configured to receive image information representing time of day from the communications conduit, and to effectuate display of time of day on the display screen, wherein the image information representing time of day is generated by a global positioning system receiver.

31. A method of displaying image information on a plurality of monitor units, the method comprising:
providing a first monitor unit, a second monitor unit, a communications conduit, and a general purpose computer;
mounting the first monitor unit in a first location, the first monitor unit comprising a first enclosure, a first display screen, a first communication port, a first power port, a first storage device, and a first control circuit, the first control circuit being electrically connected with each of the first display screen, the first communication port, the first power port, and the first storage device, the first enclosure supporting each of the first display screen, the first communication port, the first power port, the first storage device, and the first control circuit, wherein the first control circuit does not comprise a general purpose computer and is unable to operate an off-the-shelf operating system;
mounting the second monitor unit in a second location, the second monitor unit comprising a second enclosure, a second display screen, a second communication port, a second power port, a second storage device, and a second control circuit, the second control circuit being electrically connected with each of the second display screen, the second communication port, the second power port, and the second storage device, the second enclosure supporting each of the second display screen, the second communication port, the second power port, the second storage device, and the second control circuit, wherein the second control circuit does not comprise a general purpose computer and is unable to operate an off-the-shelf operating system;
connecting the communications conduit to the first communication port and to the second communication port in a sequential arrangement;
connecting the general purpose computer to the communications conduit;
transferring control information and image information from the general purpose computer to the first monitor unit over the communications conduit;
storing within the first storage device the control information and the image information received by the first monitor unit;
transferring control information and image information from the general purpose computer to the second monitor unit over the communications conduit;
storing within the second storage device the control information and the image information received by the second monitor unit;
providing at least some of the stored image information in the first storage device to the first display screen in accordance with the stored control information in the first storage device, and
providing at least some of the stored image information in the second storage device to the second display screen in accordance with the stored control information in the second storage device.

32. The method of claim 31 further comprising receiving over the communications conduit by the first monitor unit and the second monitor unit image information comprising data representing time of day, and displaying time of day on the first display screen and the second display screen in accordance with the received data.

33. A method of displaying advertisements on a monitor unit, the monitor unit being connected sequentially along a communications conduit with other monitor units and being individually and selectively addressable by a general purpose computer over the communications conduit, the method comprising:
providing a monitor unit having a storage device, a control circuit, and a display, the control circuit being connected with a communications conduit, wherein the control circuit does not comprise a general purpose computer and is unable to operate an off-the-shelf operating system;
receiving control information and image information from a general purpose computer over the communications conduit, the image information comprising a plurality of advertisement images;
storing the control information and the image information within the storage device;
processing the control information and the image information with the control circuit; and
displaying at least some of the image information upon the display as directed by the control information.

34. The method of claim 33 wherein the displaying function involves the sequential presentation of the images upon the display in accordance with the control information as to the order of images displayed and the presentation time for each image.

35. The method of claim 33 wherein the monitor unit is provided within one of an elevator cab and an elevator lobby.
